(19) United States
(12) Patent Application Publication
(10) Pub. No.: US 2026/0149680 A1
(43) Pub. Date: May 28, 2026

(54) SELECTING CHANNELS AND SENDERS FOR COMMUNICATION SERVICES PLATFORMS

(71) Applicant: Twilio Inc., San Fancisco, CA (US)

(72) Inventors: Riivo Kikas, Tallinn (EE); Benjamin Adam Croes, Oakland, CA (US); Lee Humby, London (GB); Meelis Aus, Viimsi vald (EE)

(21) Appl. No.: 18/959,161

(22) Filed: Nov. 25, 2024

(51) Int. Cl. H04L 51/066

(52) U.S. Cl. CPC H04L 51/066

(57) ABSTRACT

A message to be sent to a specified destination is received by one or more processors of a communication services platform. A plurality of sending options for the specified destination is identified. Each sending option of the plurality of sending options utilizes at least one combination of a channel and a corresponding sender. For each sending option of the plurality of sending options, a corresponding message conversion rate is determined based on feedback data reflecting message delivery by one or more message routing providers to the specified destination. A plurality of rankings of respective sending options is determined based on respective message conversion rates. A sending option having an optimal ranking is selected among the plurality of sending options. The message is sent via the selected sending option.

### TECHNICAL FIELD

Aspects and embodiments of the present disclosure relate to communication services platforms, and in particular to selecting channels and senders for communication services platforms.

### BACKGROUND

Communication services platforms can offer various messaging services to users, such as tools that enable sending and/or receiving bulk messages or messages targeted to individual recipients.

### BRIEF DESCRIPTION OF DRAWINGS

Various embodiments in accordance with the present disclosure will be described with reference to the drawings, in which:

FIG. 1 is an example system architecture of a communication services platform, in accordance with an embodiment;

FIG. 2 is a block diagram illustrating example sending options, in accordance with an embodiment;

FIG. 3 is a block diagram of an example communication services platform, in accordance with an embodiment;

FIG. 4 is a flow diagram of an example method of estimating message conversion rates based on message delivery data reported by multiple customers, in accordance with an embodiment;

FIG. 5 is a flow diagram of an example method for selecting channels and senders for communication services platforms, in accordance with an embodiment; and

FIG. 6 illustrates an example computer system, in accordance with an embodiment.

### DETAILED DESCRIPTION

Communication services platforms can offer various messaging services to users, such as tools that enable sending and/or receiving bulk messages or messages targeted to individual recipients. Communication services platforms can support a variety of communication channels. Communications channels can refer to the various communication methods, technologies, and platforms through which another platform enables interactions between clients and their end users. Examples of channels include Short Messaging Service (SMS), Multimedia Messaging Service (MMS), Rich Communication Services (RCS) (including, e.g., RCS Business Messaging (RBM)), voice calls (via PSTN, cellular, VoIP, or similar), video calls, instant messaging (e.g., WhatsApp, Facebook Messenger), electronic mail, and others. Communication services platforms can provide a layer of abstraction that hides the nuances of each of these channels and provides a uniform interface to users. Customers (e.g., users) of a communication services platform can use the communication services platform to engage with their end users through the platform's messaging tools without having to understand the details of each underlying channel.

A communication services platform can face challenges related to selecting an optimal channel to deliver a message to a specified recipient and foster engagement (conversion). Different channels can perform better or worse than other channels in different regions and at different times. In addition to performance differences, different channels may be associated with different costs per message in different regions and at different times. Furthermore, different recipients can be more or less responsive to different channels. As a result of these challenges, customers of communication services platforms can experience difficulty connecting reliably with their end users, and communication services platforms can experience unnecessary financial and/or technical burdens related to using suboptimal channels or resending undelivered or unconverted messages.

Aspects of the present disclosure addresses these and other challenges by using feedback from message delivery or user interaction to determine up-to-date conversion rates for each channel on a granular level (e.g., per destination). These conversion rates can be used to rank channels at a given time and select an optimal channel for delivering a specific message to a recipient. These conversion rates can additionally be used to detect outages in channels. Furthermore, aspects of the present disclosure provide fallback channels to which messages can be redirected in the event of an outage or suboptimal performance with a primary channel. Accordingly, communication services platforms and their customers using the techniques described herein can experience improved engagement with end users and improved reliability and reduced costs associated with delivering messages. The present disclosure addresses the technical problem of selecting an optimal channel for delivering a message based on message delivery feedback reflecting a channel's past performance in delivering messages.

A technical solution to the above-identified technical problem involves determining message conversion rates for different channels based on respective message delivery feedback for each technology, which can then be used to determine relative rankings of the channels and to select an optimal channel.

Thus, the technical effect includes using message delivery data for making channel decisions, thus increasing message conversion rates and improving user engagement, as well as improving reliability and reducing costs associated with delivering messages.

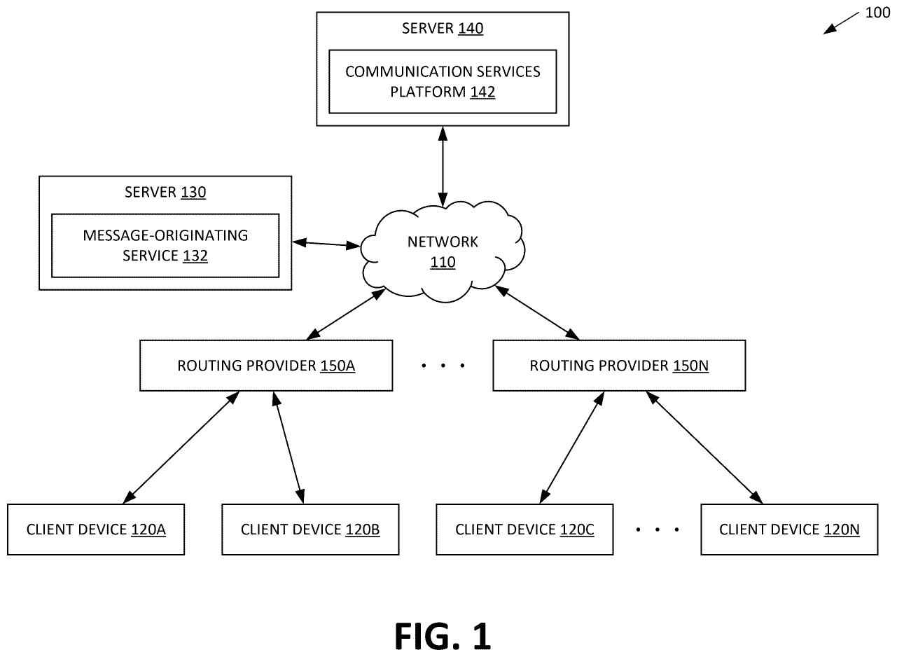

FIG. 1 is a block diagram of an example system architecture 100 for selecting channels and senders for communication services platforms, in accordance with an embodiment. System architecture 100 (also referred to as “system” herein) includes network 110, client devices 120A-N, servers 130-140, and routing providers 150A-N. In various embodiments, system 100 can include more or fewer components in different configurations than those depicted in FIG. 1.

Network 110 can include a public network (e.g., the Internet), a private network (e.g., a LAN, a WAN, a VPN, an enterprise network), a wired network (e.g., Ethernet), a wireless network (e.g., an 802.11 Wi-Fi network), a cellular network (e.g., a 5G network), routers, hubs, switches, server computers, or a combination thereof. Network 110 or components thereof can be associated with different organizations in various embodiments. For example, components of network 110 can be associated with Internet Service Providers (ISPs), mobile or cellular carriers, cloud platform or software-as-a-service (SaaS) providers, private or public enterprises, private households or communities, etc. In an embodiment, network 110 (or a component thereof) can be a physical or virtual interconnect within a single device, such as a PCIe bus, a messaging system, or an API.

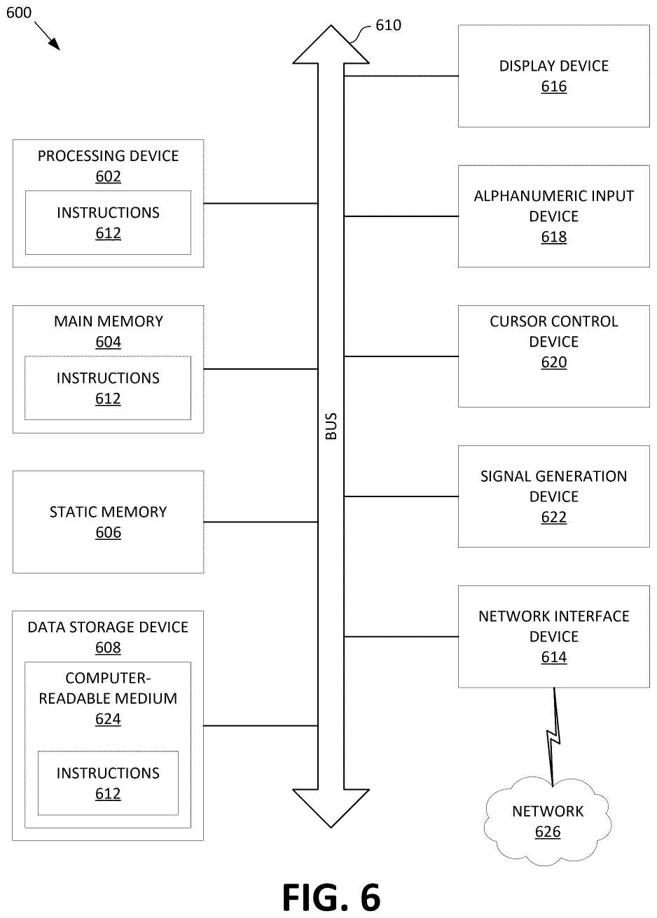

Client devices 120A-N can be personal computers (PCs), laptops, notebook computers, mobile phones, smartphones, tablet computers, digital assistants, network-connected televisions (e.g., smart TVs), or any other computing devices. The computer system of FIG. 6 can be an example of a client device. In various embodiments, client devices 120A-N can also be referred to as “user devices” or “recipient devices.” In an embodiment, a client device of client devices 120A-N can be a destination of a message and can be associated with a destination identifier such as a phone number, a username, and email address, or similar. Client devices 120A-N can run an operating system (OS) that manages hardware and software of the client devices. Client devices 120A-N can further include a web browser, application, or other software for receiving messages. Client devices 120A-N can be used by users such as recipients of messages, who can be end-users of one or more message-originating entities, each of which in turn can be a customer of the communication services platform). In general, and as described below, functions described in embodiments as being performed by a message-originating entity (e.g., a customer of the communication services platform), communication services platform, and/or server devices 130-140 can also or alternatively be performed on client devices 120A-N in other embodiments. In addition, the functionality attributed to a particular component can be performed by different or multiple components operating together.

Each of servers 130-140 can be a rackmount server, a router computer, a personal computer, a portable digital assistant, a mobile phone, a laptop computer, a tablet computer, a netbook, a desktop computer, a virtual machine (VM), etc., or any combination of the above. The computer system of FIG. 6 can be an example of a server. In various embodiments, each of servers 130-140 can be several computing devices, such as multiple rackmount servers in a data center(s) or multiple VMs in a cloud platform. In an embodiment, functions provided by servers 130-140 can alternatively be provided by a single server device.

Server 130 can implement message-originating service 132. Message-originating service 132 can be implemented by a hardware (e.g., circuitry, dedicated logic, etc.) or software (e.g., code, libraries, firmware, etc.) tool of a message-originating entity, such as a customer of the communication services platform, that sends messages to destinations and/or recipients, such as client devices 120A-N. The customer can be a person, business, company, and/or any other type of entity that uses system 100 to transmit messages to intended recipients. Message-originating service 132 can send messages to destinations and/or recipients using communication services platform 142. For example, message-originating service 132 can send informational messages (e.g., links to content, promotions), authentication messages (e.g., one-time passcodes, password resets), or other types of messages to client devices 120A-N via communication services platform 142. The customer can use the functionality of system 100 as part of a service provided by the customer. The customer may provide various types of services to its end users, such as a banking service, travel service, retail service, and the like.

Server 140 includes communication services platform 142. Communication services platform can be a hardware or software tool of a communication services platform that receives messages addressed to one or more destinations/recipients and sends the messages to their respective destinations/recipients using one or more routing providers. For example, communication services platform 142 can receive a message from message-originating service 132 and can send the received message to one or more of client devices 120A-N using one or more of routing providers 150A-N.

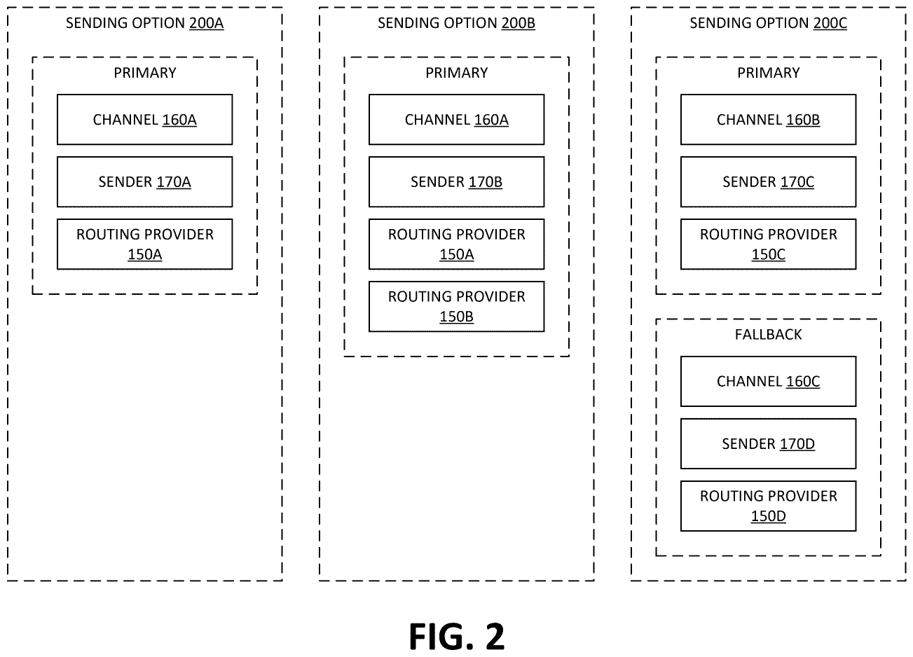

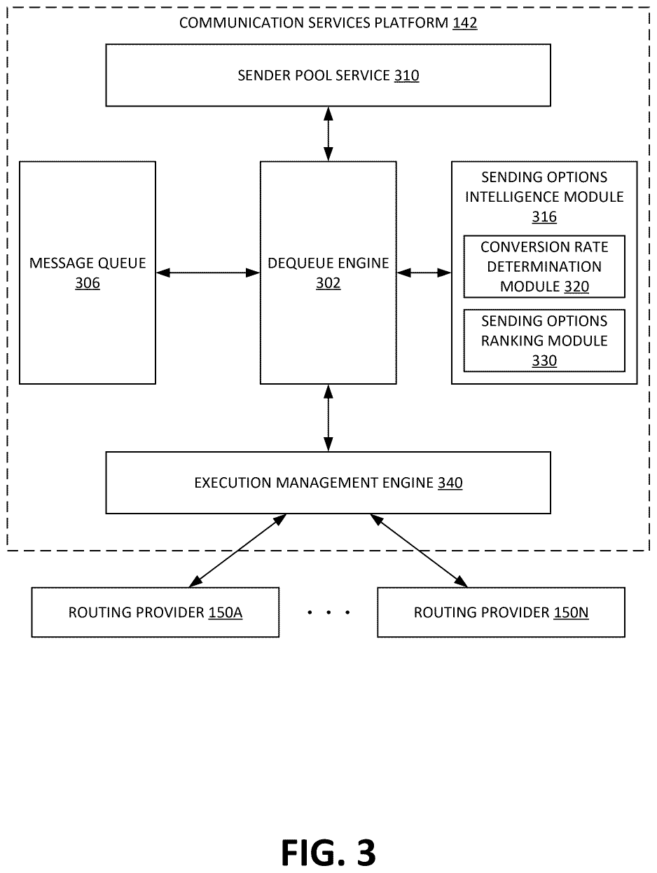

In an embodiment, communication services platform 142 can identify one or more sending options for the destination(s), such as various combinations of communication channels and senders. Communication services platform 142 can determine one or more metrics for each sending option (e.g., based on feedback data collected from routing providers) and rank the sending options based on the metrics. For example, communication services platform 142 can rank sending options based on message conversion rates, message delivery costs, etc. Communication services platform 142 can select a sending option having an optimal ranking (e.g., highest ranking, lowest ranking, ranking exceeding a threshold value) for sending the message, such as a sending option having the highest conversion rate or lowest maximum message delivery cost. Sending options are further described with reference to FIG. 2. An example communication services platform is further described with reference to FIG. 3.

Routing providers 150A-N can each be an entity for routing messages to recipients. Examples of routing providers include telecommunication providers (e.g., cellular carriers), instant messaging platforms, email providers, and others. Each of routing providers 150A-N can be associated with a physical or virtual destination, such as a geographic region, a Mobile Country Code (MCC)/Mobile Network Code (MNC) tuple, a domain name, or similar.

In an embodiment, message-originating service 132 can communicate with communication services platform 142 using one or more function calls, such as application programming interface (API) function calls (also referred to as “API calls” herein). For example, the one or more function calls can be identified in a request using one or more application layer protocols, such a HyperText Transfer Protocol (HTTP) (or HTTP secure (HTTPS)), and that are sent to communication services platform 142 from message-originating service 132. In some embodiments, communication services platform 142 can respond to the requests from message-originating service 132 by using one or more API responses using an application layer protocol. Similarly, communication services platform 142 can communicate with one or more of routing providers 150A-N using API function calls. Examples of APIs that can be used include a REST (Representational State Transfer) API, a GraphQL API, or a SOAP (Simple Object Access Protocol) API, among others.

In situations in which the systems discussed here collect personal information about users, or may make use of personal information, the users can be provided with an opportunity to control whether message-originating service 132, communication services platform 142, and/or routing providers 150A-N collect user information, or to control whether and/or how to receive content from the above components that may be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the above components.

FIG. 2 is a block diagram illustrating example sending options 200A-C, in accordance with an embodiment. Channels 160A-N can each be a mode of communication or a messaging technology for communicating information between message originating entities and message recipients. Examples of channels can include Short Messaging Service (SMS), Multimedia Messaging Service (MMS), Rich Communication Services (RCS) (including, e.g., RCS Business Messaging or RBM), voice calls (via PSTN, cellular, VoIP, or similar), video calls, instant messaging (e.g., WhatsApp), email, and others. Channels can be synchronous (e.g., voice, video) and/or asynchronous (e.g., SMS, email). Channels can be used to transmit messages over shared media such as network 110 or dedicated media such as a Public Switched Telephone Network (PSTN). Different channels can be associated with other shared or distinguishing characteristics not described herein.

Senders 170A-N can each be an identifier of a communication endpoint used by a communication services platform to send a message. Examples of senders include an originating phone number (e.g., 10-digit long code or short phone number for SMS), an originating username, an originating email address, a Verified Sender Identity (e.g., for RCS) or similar. In an embodiment, a message sent using one of senders 170A-N can be routed to a destination or recipient using one of routing providers 150A-N.

In an embodiment, each routing provider and/or channel can provide varying levels of performance. For example, the likelihood that a message will be successfully delivered to or engaged with by the recipient can vary among the routing providers and channels. Further, the performance of each sender and/or channel can vary over time. Senders using multiple channels (e.g., RCS with SMS fallback) can similarly provide varying performance.

Referring to sending option 200A, a sending option can include a combination of a channel and sender and can be associated with a routing provider. Sending option 200A includes channel 160A and corresponding sender 170A. For example, channel 160A can be SMS and sender 170A can be a 10-digit long code originating phone number. Routing provider 150A can route messages sent using channel 160A and sender 170A to a destination or recipient. For example, routing provider 150A can be a cellular network carrier that supports SMS.

Referring to sending option 200B, multiple senders can be used with the same channel in an embodiment. Like sending option 200A, sending option 200B includes channel 160A, but the corresponding sender is sender 170B. For example, sender 170B can be a short code originating phone number for the same SMS channel. In an embodiment, multiple routing providers can be available to route messages sent using a channel-sender combination. For example, routing providers 150A-B can be different cellular network carriers covering the same or different geographic regions.

Referring to sending option 200C, a sending option can include multiple channel-sender combinations. Channel 160B and sender 170C can be the primary combination (e.g., using RCS), and channel 160C and sender 170D can be the fallback combination (e.g., using SMS if/when RCS is unavailable).

FIG. 3 is a block diagram of an example communication services platform 142, in accordance with an embodiment. Communication services platform 142 includes dequeue engine 302, message queue 306 sender pool service 310, sending options intelligence module 316, and execution management engine 340. In various embodiments, communication services platform 142 can include more or fewer components in different configurations than those depicted in FIG. 3.

Dequeue engine 302 can retrieve messages to be sent from message queue 306 and can coordinate identification and selection of optimal sending options. Dequeue engine 302 can communicate with sender pool service 310 to identify sending options for a destination or recipient. Sending options identified by service 310 can include channels and corresponding senders, as described with reference to the examples in FIG. 2.

Dequeue engine 302 can provide a list of sending options to sending options intelligence module 316 to determine an optimal sending option. Sending options intelligence module 316 includes conversion rate determination module 320 and sending options ranking module 330. Conversion rate determination module 320 calculates a conversion rate for each of the sending options based on feedback data from routing providers associated with each sending option. Feedback data can include data describing whether a routing provider transmitted the allocated message to its intended recipient, whether the message was successfully received by its intended recipient, whether the message resulted in a specified action by the recipient (e.g., entering a one-time passcode in another application), an amount of time that elapsed until the message was transmitted by the routing provider, an amount of time that elapsed until the message was received by the recipient, and the like.

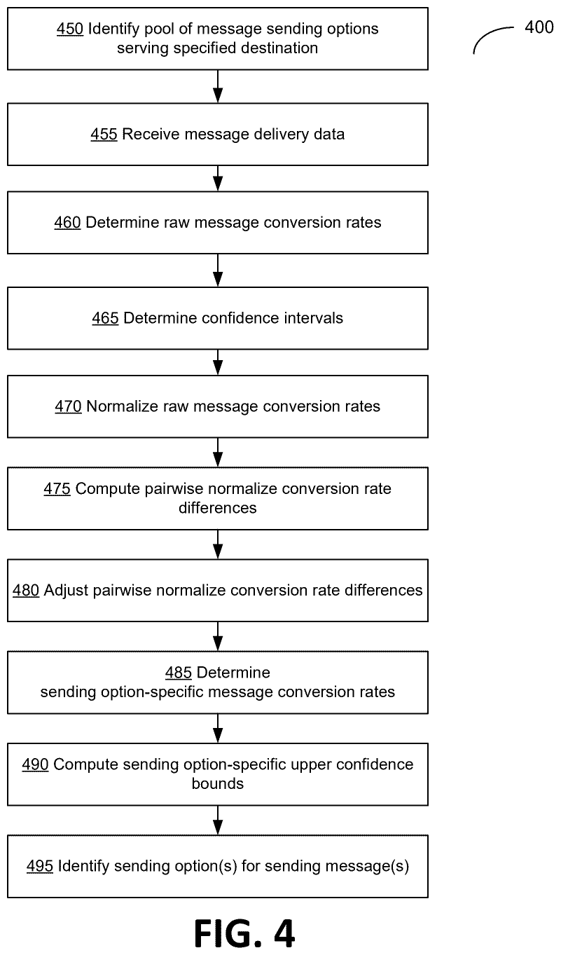

Conversion rate determination module 320 can calculate the conversion rates. For example, the conversion rate can be based on a ratio of the messages transmitted by associated routing providers that were successfully delivered. In an embodiment, the conversion rates determined for each sending option can be an upper confidence bound estimate. An upper confidence bound estimate provides an optimistic estimate of the performance of each sending option based on the amount of feedback data available. As the upper confidence bound estimate is based on available feedback data, the upper confidence bound estimate for sending options with limited feedback data will be amplified due to the limited amount of feedback data available. Conversion rates and calculations thereof are further described with reference to FIG. 4.

Sending options ranking module 330 can determine relative rankings for the sending options based on various criteria. In an embodiment, module 330 can determine relative rankings based solely on the conversion rate data determined by module 320. In an embodiment, module 330 can determine relative rankings based on the conversion rate data and pricing data, such as the maximum or average price per message sent for each sending option. Other criteria that can be used include sending option timing statistics (e.g., elapsed time until transmit, elapsed time until reception, routing option congestion, routing option outage frequency, etc. Ranking module 330 can further select a sending option having an optimal ranking (e.g., highest, lowest, exceeding a threshold, etc.) for communication services platform 142 to use to send a message.

Dequeue engine can receive sending options ranks and/or an indication of an optimal sending option from sending options intelligence module 316. Dequeue engine can provide a message to be sent and an indication of the optimal sending option to execution management engine 340. Execution management engine 340 can communicate with routing providers associated with the optimal sending option (e.g., routing providers 150A-N) to send the message to the intended recipient.

FIG. 4 is a flow diagram of an example method 400 of estimating message conversion rates based on message delivery data reported by multiple customers, in accordance with aspects of the present disclosure. The method 400 can be performed for each sending option that is provided by the communication services platform. The method 400 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some implementations, the method 400 is performed by the one or more modules (e.g., sending options intelligence module 316, conversion rate determination module 320, or sending option ranking module 330) of communication services platform 142 of FIG. 3. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 450, the processing logic implementing the method identifies a pool of message sending options serving a specified destination, as described in more detail herein above.

At operation 455, the processing logic receives, from multiple message-originating entities (e.g., customers of the communication services platform) message delivery data reflecting message delivery by the pool of message sending options to the specified destination. The message delivery data provided to the communication services platform by each customer includes, for each message sending option that has been employed to route the customer's messages, the number of messages routed and the number of messages successfully delivered. The message delivery data may be sent periodically by each customer to the communication services platform, such that the communication services platform may maintain the cumulative total numbers of messages routed and successfully delivered by each sending option for each customer.

At operation 460, the processing logic determines, based on the message delivery data, a set of raw message conversion rates for respective message sending options and customers. Each raw message conversion rate of the set of raw message conversion rates is computed as the ratio of the number of delivered messages to the number of sent messages by a given message sending option for a given customer:

$${CR}_{ij} = {D}_{ij} / {R}_{ij} ,$$

where CRᵢⱼ is the message conversion rate for message sending option i sending messages originated by customer j, Dᵢⱼ is the number of messages successfully delivered by message sending option i for customer j, and Rᵢⱼ is the number of messages sent by message sending option i for customer j.

At operation 465, the processing logic determines, for each raw message conversion rate of the set of computed raw message conversion rates, a corresponding confidence interval. The confidence interval reflects the number of sent messages by a given message sending option to a given customer. In some implementations, the confidence interval can be computed based on the Student's distribution with specified desired distribution parameters (e.g., 95% confidence interval).

In an embodiment, the processing logic can proceed to operation 490 and use the conversion rates and confidence intervals to computer provider-specific upper confidence bounds (e.g., operations 470-485 can be omitted in an embodiment).

At operation 470, the processing logic normalizes each customer's set of raw message conversion rates by the maximum raw message conversion rate among the set of raw message conversion rates:

CRNᵢⱼ=CRᵢⱼ/maxᵢ(CRᵢⱼ),
where CRNᵢⱼ is the normalized message conversion rate for message sending option i sending messages originated by customer j, and maxᵢ (CRᵢⱼ) is the maximum message conversion rate among all message conversion rates for customer j.

At operation 475, the processing logic computes the pairwise normalized message conversion rate differences for each pair of message sending options based on the message delivery data of a given customer. Accordingly, for customer j, a set of pairwise differences is computed CRNₖⱼ-CRNᵢⱼ for all sending options k and 1, where k≠1.

At operation 480, the processing logic calculates the average weighted pairwise differences of normalized conversion rate across all customers for each message sending option pair. The weight coefficients may be chosen as the inverse squared sum of the confidence interval values of the corresponding message sending option pair:

$${w}_{klj} = 1 / {( {CI}_{kj} + {CI}_{lj} )}^{2} ,$$

where wₖₗⱼ is the weight coefficient to be applied to the pairwise message conversion rate difference of message sending options k and l based on the message delivery data of the customer j. Accordingly, the adjusted pairwise normalized message conversion rate differences calculated across all customers can be expressed as follows:

$${CR}_{k} - {CR}_{1} = ( {\sum }_{k} ( {CRN}_{kj} - {CRN}_{lj} ) * {w}_{klj} ) / {\sum }_{k} {w}_{klj}$$

where CRₖ and CRₗ are message conversion rates for sending options k and l respectively, based on the message delivery data reported by multiple customers. The pairwise differences form a system of linear equations for which each equation is linearly weighted by wₖₗⱼ.

At operation 485, the processing logic solves the system of linear equations formed by the adjusted pairwise normalized message conversion rate differences computed at operation 480. The solution may be obtained by solving a convex linear optimization task with the objective to minimize the least squared error and while bounding the resulting conversing rate to be between 0 and 1.

The solution may be shifted such that the message sending option with the highest normalized message conversion rate has the highest possible message conversion rate (i.e., 100%). This determines provider-specific message conversion rates.

At operation 490, the processing logic aggregates the messages sent by each message sending option based on the message delivery data, thus computing provider-specific UCBs of message conversion rates:

$${UCB}_{i} = {CR}_{i} + {CI}_{i} ,$$

where UCBᵢ is the upper confidence bound for message sending option i based on the message delivery data reported by all customers, and CIᵢ is the confidence interval for message sending option i computed based on the number of messages sent.

At operation 495, the processing logic identifies one or more message sending options for sending one or more messages to the destination. In some implementations, the sending decisions may be made based on the message conversion rates for respective message sending options computed at operation 485. Alternatively, the sending decisions may be made based on the upper confidence bounds of message conversion rates for respective message sending options computed at operation 490.

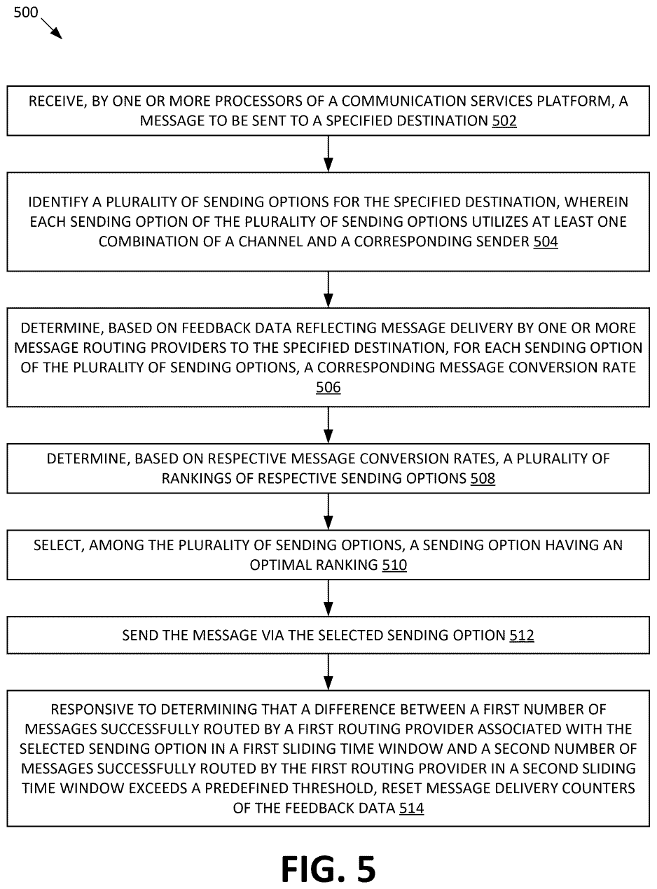

FIG. 5 is a flow diagram of an example method 500 for selecting channels and senders for communication services platforms, in accordance with an embodiment. Method 500 can be performed by processing logic that can comprise hardware (e.g., circuitry, dedicated logic, etc.), computer-readable instructions such as software or firmware (e.g., run on a general-purpose computing system or a dedicated machine), or a combination thereof. For instance, an example system can include a memory and a processing device coupled to the memory device to perform operations comprising the blocks of method 500. Method 500 can also be associated with a set of instructions stored on a non-transitory computer-readable medium (e.g., magnetic or optical disk, etc.). The instructions, when executed by a processing device, can cause the processing device to perform operations comprising the blocks of method 500. In an embodiment, method 500 is performed by server 140 or communication services platform 142 of FIG. 1. In an embodiment, method 500 is performed by computing system 600 of FIG. 6. In some embodiments, blocks depicted in FIG. 5 could be performed simultaneously or in a different order than depicted. Various embodiments can include additional blocks not depicted in FIG. 5 or a subset of blocks depicted in FIG. 5. For example, block 514 can be absent in an embodiment.

At block 502, processing logic of a communication services platform receives a message to be sent to a specified destination. The message can be or can include various types of information such as one-time passcodes, password resets, media content, hyperlinks, promotions, etc. The message can further be associated with metadata that include an identifier of the specified destination or a recipient in/at the specified destination. For example, the message metadata can include a recipient phone number, email address, username, or similar. In an embodiment, the specified destination can be the recipient itself, such as one of client devices 120A-N. In an embodiment, the specified destination can be a physical or virtual region hosting the recipient. For example, the specified destination can be a city, state, or country. In another example, the specified destination can be an MCC/MNC tuple, an area code (or other phone number prefix), a domain name, or similar.

At block 504, the processing logic identifies a plurality of sending options for the specified destination, wherein each sending option of the plurality of sending options utilizes at least one combination of a channel and a corresponding sender. As previously described, channels can include SMS, MMS, RCS, voice, video, instant messaging platforms, email, or similar. A corresponding sender provides an identity and capabilities to send messages using the associated channel. For example, an email sender can be associated with an email address identity. Multiple senders can utilize the same channel. For example, a 10-digit long code sender and a short code sender can both utilize the SMS channel. Senders and channels can further be associated with one or more routing providers that route messages to the specified destination or recipient. A sending option can include multiple combinations of channel/sender pairs. For example, a sending option can include a primary sender/channel and a fallback sender/channel.

In an embodiment, the plurality of sending options comprises a first sending option and a second sending option, wherein the first sending option of the plurality of sending options utilizes a first combination of a first sender and a first channel, and wherein the second sending option of the plurality of sending options utilizes the first combination and a second combination of a second sender and a second channel. For example, the first channel can be short messaging service (SMS) and the second channel can be rich communication services (RCS). SMS can be a fallback for RCS or vice versa. In an embodiment, the plurality of sending options further comprises a third sending option, wherein the third sending option of the plurality of sending options utilizes the second combination.

In an embodiment, the plurality of sending options comprises a first sending option utilizing a first channel, and wherein the first channel is one of: multimedia messaging service (MMS), voice, email, or instant messaging.

In an embodiment, identifying the plurality of sending options for the specified destination comprises determining that a first channel is eligible for use for sending the message to the specified destination. For example, the processing logic can query a relevant routing provider or other component to determine whether messages can be routed using the channel to the specified destination or recipient.

At block 506, the processing logic determines, based on feedback data reflecting message delivery by one or more message routing providers to the specified destination, for each sending option of the plurality of sending options, a corresponding message conversion rate. The feedback data can include delivery confirmation data provided by a routing provider in response to successfully delivering a message. The feedback data can additionally or alternatively include data corresponding to actions taken by recipients of messages in response to receiving messages, such as entering a one-time passcode contained in a message into a web browser or other application. In an embodiment, the feedback data can include data associated with multiple destinations and can be segmented by destination. For example, the feedback data can be segmented by geographical region, by MCC/MNC tuple, by domain name, or similar. In an embodiment, each message conversion rate reflects, for a corresponding sending option, a ratio of a number of successfully delivered messages and a number of sent messages.

At block 508, the processing logic determines, based on respective message conversion rates, a plurality of rankings of respective sending options. For example, higher respective message conversion rates can lead to higher-ranked sending options. In various embodiments, other factors can be used in place of or in addition to message conversion rates to determine the rankings of the sending options. For example, maximum or average per-message cost can be used to rank sending options, with lower-cost options ranking higher.

At block 510, the processing logic selects, among the plurality of sending options, a sending option having an optimal ranking. In an embodiment, selecting the sending option further comprises determining that the selected sending option satisfies a cost criterion specifying a maximum message delivery cost.

At block 512, the processing logic sends the message via the selected sending option.

At block 514, responsive to determining that a difference between a first number of messages successfully routed by a first routing provider associated with first routing option in a first sliding time window and a second number of messages successfully routed by the first routing provider in a second sliding time window exceeds a predefined threshold, the processing logic resets message delivery counters of the feedback data. The processing logic can compare the conversion rates in the two time windows to determine whether there has been an outage with the associated channel.

FIG. 6 is a block diagram illustrating an example computer system 600, in accordance with implementations of the present disclosure. Computer system 600 may be client devices 120A-N, servers 130-140, or routing providers 150A-N, as described above with reference to FIG. 1. Computer system 600 may operate in the capacity of a server or an endpoint machine in endpoint-server network environment, or as a peer machine in a peer-to-peer (or distributed) network environment. The machine may be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 600 includes processing device 602 (e.g., one or more processors or cores), main memory 604 (e.g., read-only memory (ROM), flash memory, dynamic random access memory (DRAM) such as synchronous DRAM (SDRAM), double data rate (DDR SDRAM), or DRAM (RDRAM), etc.), static memory 606 (e.g., flash memory, static random access memory (SRAM), etc.), and data storage device 608, which communicate with each other via bus 610.

Processing device 602 represents one or more general-purpose processing devices such as a microprocessor, central processing unit, or the like. More particularly, processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute instructions 612 (e.g., for storing contextual data with context schemas) for performing the operations discussed herein.

Computer system 600 may further include network interface device 614. Computer system 600 also may include display device 616 (e.g., a liquid crystal display (LCD) or a cathode ray tube (CRT)), alphanumeric input device 618 (e.g., a keyboard, and alphanumeric keyboard, a motion sensing input device, touch screen), cursor control device 620 (e.g., a mouse), and signal generation device 622 (e.g., a speaker). In some embodiments, computer system 600 may not include display device 616, alphanumeric input device 618, and/or cursor control device 620 (e.g., in a headless configuration).

Data storage device 608 may include a non-transitory machine-readable storage medium 624 (also computer-readable storage medium) on which is stored one or more sets of instructions 612 (e.g., for storing contextual data with context schemas) embodying any one or more of the methodologies or functions described herein. Instructions 612 may also reside, completely or at least partially, within main memory 604 or within the processing device 602 during execution thereof by computer system 600, main memory 604 and processing device 602 also constituting machine-readable storage media. Instructions 612 may further be transmitted or received over network 626 via network interface device 614.

In one implementation, instructions 612 include instructions for storing contextual data with context schemas, as described herein. While computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method, comprising:
identifying, by one or more processors of a communication services platform, a plurality of sending options for sending a message to a specified destination, wherein each sending option of the plurality of sending options utilizes at least one combination of a channel and a corresponding sender;
determining, for each sending option of the plurality of sending options, a corresponding message conversion rate;
selecting, among the plurality of sending options, a sending option based on the corresponding message conversion rates; and
sending the message via the selected sending option.

2. The method of claim 1, wherein the plurality of sending options comprises a first sending option and a second sending option, wherein the first sending option of the plurality of sending options utilizes a first combination of a first sender and a first channel, and wherein the second sending option of the plurality of sending options utilizes the first combination and a second combination of a second sender and a second channel.

3. The method of claim 2, wherein the first channel is short messaging service (SMS) and the second channel is rich communication services (RCS).

4. The method of claim 2, wherein the plurality of sending options further comprises a third sending option, wherein the third sending option of the plurality of sending options utilizes the second combination.

5. The method of claim 1, wherein determining, for each sending option of the plurality of sending options, a corresponding message conversion rate is based on feedback data reflecting message delivery by one or more message routing providers to the specified destination.

6. The method of claim 5, further comprising:
responsive to determining that a difference between a first number of messages successfully routed by a first routing provider associated with the selected sending option in a first sliding time window and a second number of messages successfully routed by the first routing provider in a second sliding time window exceeds a predefined threshold, resetting message delivery counters of the feedback data.

7. The method of claim 5, wherein each message conversion rate reflects, for a corresponding sending option, a ratio of a number of successfully delivered messages and a number of sent messages.

8. The method of claim 1, wherein selecting, among the plurality of sending options, a sending option based on the corresponding message conversion rates comprises:
determining, based on respective message conversion rates, a plurality of rankings of respective sending options; and
selecting, among the plurality of sending options, a sending option having an optimal ranking.

9. The method of claim 1, wherein selecting the sending option further comprises:
determining that the selected sending options satisfies a cost criterion specifying a maximum message delivery cost.

10. The method of claim 1, wherein the plurality of sending options comprises a first sending option utilizing a first channel, and wherein the first channel is one of: multimedia messaging service (MMS), voice, email, or instant messaging.

11. The method of claim 1, wherein identifying the plurality of sending options for the specified destination comprises:
determining that a first channel is eligible for use for sending the message to the specified destination.

12. A system comprising:
a memory device; and
a processing device coupled to the memory device, the processing device to perform operations comprising:
identifying, by a communication services platform, a plurality of sending options for sending a message to a specified destination, wherein each sending option of the plurality of sending options utilizes at least one combination of a channel and a corresponding sender;
determining, for each sending option of the plurality of sending options, a corresponding message conversion rate;
selecting, among the plurality of sending options, a sending option based on the corresponding message conversion rates; and
sending the message via the selected sending option.

13. The system of claim 12, wherein the plurality of sending options comprises a first sending option and a second sending option, wherein the first sending option of the plurality of sending options utilizes a first combination of a first sender and a first channel, and wherein the second sending option of the plurality of sending options utilizes the first combination and a second combination of a second sender and a second channel.

14. The system of claim 13, wherein the first channel is short messaging service (SMS) and the second channel is rich communication services (RCS).

15. The system of claim 13, wherein the plurality of sending options further comprises a third sending option, wherein the third sending option of the plurality of sending options utilizes the second combination.

16. The system of claim 12, wherein selecting, among the plurality of sending options, a sending option based on the corresponding message conversion rates comprises:
determining, based on respective message conversion rates, a plurality of rankings of respective sending options; and
selecting, among the plurality of sending options, a sending option having an optimal ranking.

17. A non-transitory computer-readable medium comprising instructions that, when executed by a processing device, cause the processing device to perform operations comprising:
identifying, by a communication services platform a plurality of sending options for sending a message to a specified destination, wherein each sending option of the plurality of sending options utilizes at least one combination of a channel and a corresponding sender;
determining, for each sending option of the plurality of sending options, a corresponding message conversion rate;
selecting, among the plurality of sending options, a sending option based on the corresponding message conversion rates; and
sending the message via the selected sending option.

18. The non-transitory computer-readable medium of claim 17, wherein determining, for each sending option of the plurality of sending options, a corresponding message conversion rate is based on feedback data reflecting message delivery by one or more message routing providers to the specified destination.

19. The non-transitory computer-readable medium of claim 18, wherein each message conversion rate reflects, for a corresponding sending option, a ratio of a number of successfully delivered messages and a number of sent messages.

20. The non-transitory computer-readable medium of claim 17, wherein selecting the sending option further comprises:
determining that the selected sending options satisfies a cost criterion specifying a maximum message delivery cost.
